(19) United States
(12) Patent Application Publication
(10) Pub. No.: US 2025/0372933 A1
(43) Pub. Date: Dec. 4, 2025

(54) HYDRAULIC CRIMPER FREE FROM DIE CHANGE

(71) Applicant: KUDOS MECHANICAL CO., LTD., New Taipei City (TW)

(72) Inventor: James CHUAN, New Taipei City (TW)

(21) Appl. No.: 18/805,960

(22) Filed: Aug. 15, 2024

(30) Foreign Application Priority Data
Jun. 4, 2024 (TW) 113120562

(51) Int. Cl. H01R 43/042

(52) U.S. Cl. CPC H01R 43/0427

(57) ABSTRACT

A hydraulic crimper includes a die and a main body. A distance sensing unit is installed to a fixed component of the die and senses a relative distance between a moveable component of the die and the fixed component and thus generates a distance sensing signal. The moveable component is for crimping a cable connector. A control unit of the main body determines whether a pipeline of a hydraulic jack in the main body endures a force greater than or equal to a pressure threshold. When the force is greater than or equal to the pressure threshold, the control unit calculates an outer diameter of the cable connector according to the distance sensing signal. The control unit controls the hydraulic jack for crimping the cable connector according to the outer diameter calculated. The cable connector is crimped without needs to manually measuring the outer diameter and change the die.

### BACKGROUND OF THE INVENTION

### 1. Field of the Invention

The present invention relates to a crimper, in particular to a hydraulic crimper free from die change.

### 2. Description of the Related Art

In the technical field of electric hand tools, a crimper is a tool for compressing along an axis. In industrial applications, a crimper is mainly used to crimp a cable inserted into a cable connector, so that the cable and the cable connector compressed inward by appropriate pressure are tightly engaged, thereby facilitating various cable assembly applications. To enhance the force of inward pressure output by the crimper, most of the existing crimpers have developed into hydraulic crimpers. The hydraulic crimpers that can be electrically controlled are called as electric hydraulic crimpers. At present, an electric hydraulic crimper is usually simply called a crimper, so the crimper referred to is an electric hydraulic crimper.

Currently in industrial applications, the cable connector deformed by crimping may have different outer diameters. Depending on the outer diameter of the cable connector, the inward movement distance that the crimper should compress inward will also be different. Therefore, the inward movement distance of a conventional crimper should be moved a certain distance after contacting the cable connector, so that the cable connector is appropriately deformed by pressure and the cable inserted in the cable connector is pressed inward.

When the pressure applied inward by the crimper is too great, the cable connector may be damaged and cracked. When the pressure applied inward by the crimper is too small, the cable connector may not be able to be pressed tightly against the cable, causing the cable to fall out of the cable connector. Therefore, for cable connectors with larger outer diameters, the crimper should theoretically move inward a shorter distance, because it moves inward a short distance to start contacting the cable connector. Conversely, for cable connectors with smaller outer diameters, the crimper should theoretically move inward a longer distance, because it moves inward a longer distance to start contacting the cable connector.

However, currently, for a user operating the crimper, the user needs to visually inspect the model of the cable connector to get the outer diameter of the cable connector, and then manually adjust the upper limit of the crimper's diameter and change the die corresponding to the outer diameter. When the model printed on the cable connector is unclear, the user needs to manually measure the outer diameter of the cable connector before adjusting the upper limit of the crimper's diameter and changing the die corresponding to the outer diameter. This method of operating the crimper is too labor-intensive and needs to be improved.

### SUMMARY OF THE INVENTION

In view of the above, the invention provides a hydraulic crimper free from die change, which ensures that the user can automatically measure an outer diameter of a connector to be crimped and calculate an adequate crimping distance to properly crimp the connector without manually changing the die.

A hydraulic crimper free from die change comprises:

a die including a fixed component and a movable component; wherein a distance sensing unit is installed to the fixed component, is utilized for sensing a relative distance between a moveable component of the die and the fixed component and thus correspondingly generates a distance sensing signal; a main body connected to the die and including:

a hydraulic jack, having a thrust rod, a pipeline, a hydraulic pump, and a hydraulic sensor; wherein, the pipeline connects the hydraulic pump to the thrust rod, and the hydraulic sensor senses a force on the pipeline to generate a pressure signal;

a control unit, electrically connected to the distance sensing unit of the die, the hydraulic pump, and the hydraulic sensor to receive the distance sensing signal and the pressure signal; wherein, the control unit controls the hydraulic pump to pressurize the pipeline according to a start signal to push the thrust rod toward the moveable component such that the moveable component crimps a cable connector;

wherein, when the control unit determines that the force the pipeline endures is greater than or equal to a pressure threshold according to the pressure signal, the control unit calculates an outer diameter of the cable connector according to the received distance sensing signal;

wherein, after the control unit calculates the outer diameter of the cable connector, the control unit controls the hydraulic jack to push the thrust rod toward the moveable component for an adequate crimping distance according to an instruction that corresponds to the outer diameter of the cable connector, and further controls the hydraulic jack to retract the thrust rod.

The movable component of the die can be applied to a variety of cable connectors with different outer diameters on the market, so a user of the hydraulic crimperfree from does not need to change the die to correspond to a variety of cable connectors of different outer diameters. In this way, the invention can help the user save effort in changing the die.

Furthermore, when the control unit determines the force that the pipeline endures is greater than or equal to the pressure threshold and determines that the movable component begins to contact the cable connector, the control unit can accurately measure the relative distance of the movable component relative to the fixed component according to the distance sensing signal generated by the distance sensing unit, and then calculates the outer diameter of the cable connector, so as to automatically create the corresponding instruction to push the thrust rod to the adequate crimping distance, thereby properly crimping the cable connector. The cable connector properly crimped, as described in the previous technical paragraph, can avoid being broken due to excessive force, or avoid being firmly connected to a cable inserted in the cable connector due to insufficient force. In this way, the invention can automatically and accurately calculate the outer diameter of the cable connector, thereby helping the user to save manpower to confirm the outer diameter of the cable connector, making the overall crimping operation of the cable connector smoother and more efficient.

### BRIEF DESCRIPTION OF THE DRAWINGS

FIG.1 is perspective view of a hydraulic crimper free from die change of the invention.

FIG.2 is a block diagram of a hydraulic crimper free from die change of the invention.

FIG.3 is a cross-sectional diagram of a die of hydraulic crimper free from die change of the invention before being crimped under force.

FIG.4 is a cross-sectional diagram of a die of a die of hydraulic crimper free from die change of the invention when being crimped under force.

FIGs.5 and 6 show a flow chart of steps executed by a control unit of a die of hydraulic crimper free from die change of the invention.

### DETAILED DESCRIPTION OF THE INVENTION

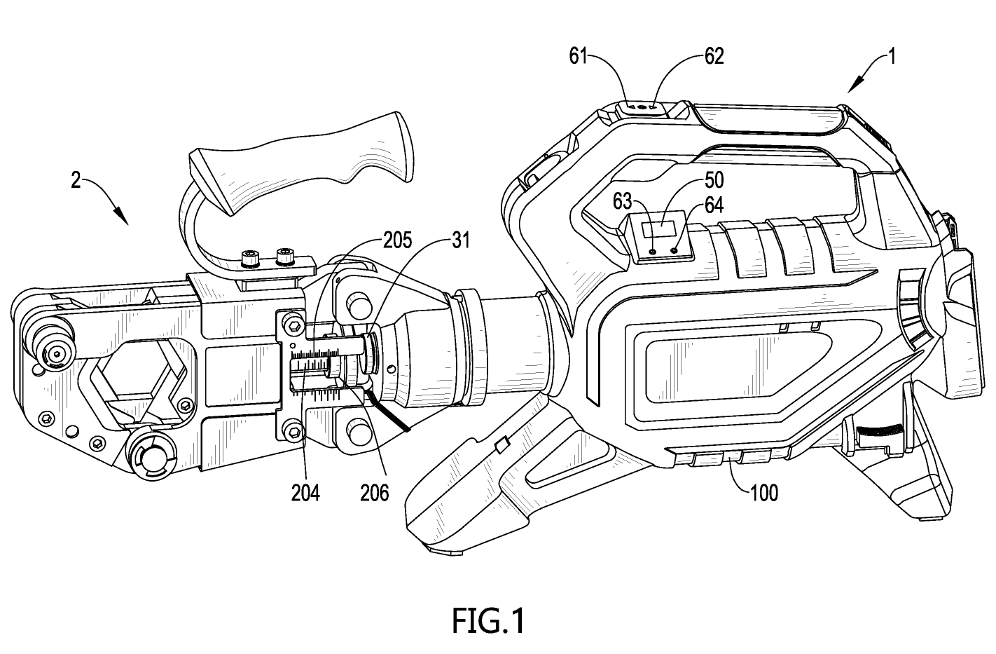

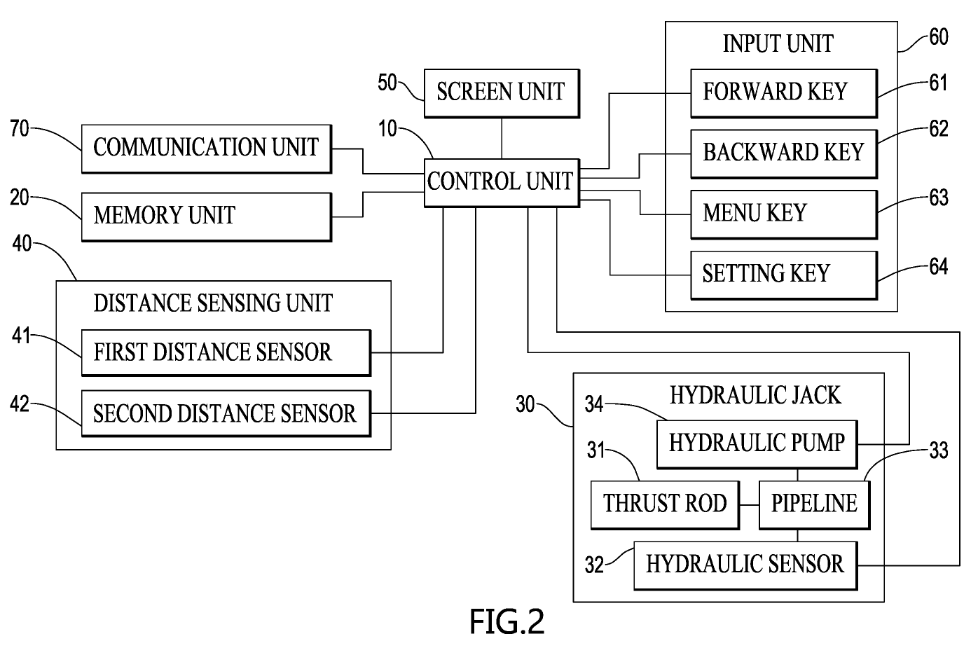

Referring to FIG. 1 and FIG. 2, a hydraulic crimper free from die change is provided in the invention. The hydraulic crimper free from die change includes a body 1 and a die 2 connected to the body 1.

The body 1 includes a housing 100. A control unit 10, a memory unit 20 and a hydraulic jack 30 are arranged in the housing 100. The control unit 10 is electrically connected to the memory unit 20 and the hydraulic jack 30.

The hydraulic jack 30 has a thrust rod 31, a hydraulic sensor 32, a pipeline 33 and a hydraulic pump 34. The hydraulic sensor 32 and the hydraulic pump 34 are electrically connected to the control unit 10, respectively. The pipeline 33 is connected between the thrust rod 31 and the hydraulic pump 34. Preferably, the hydraulic jack 30 is an oil hydraulic jack.

The control unit 10 controls the hydraulic pump 34 to work. The hydraulic pump 34 controls the hydraulic of the pipeline 33 to drive the thrust rod 31 to move. In other words, the control unit 10 indirectly controls the forward and backward movement of the thrust rod 31 along an axial direction by controlling the hydraulic pump 34. In addition, the hydraulic sensor 32 is also connected to the pipeline 33, so that the hydraulic sensor 32 senses a hydraulic pressure of the pipeline 33 and indirectly senses the force of the thrust rod 31. In this way, the hydraulic sensor 32 indirectly senses the force of the thrust rod 31 to generate a pressure signal corresponding to the hydraulic pressure, and transmits the pressure signal to the control unit 10.

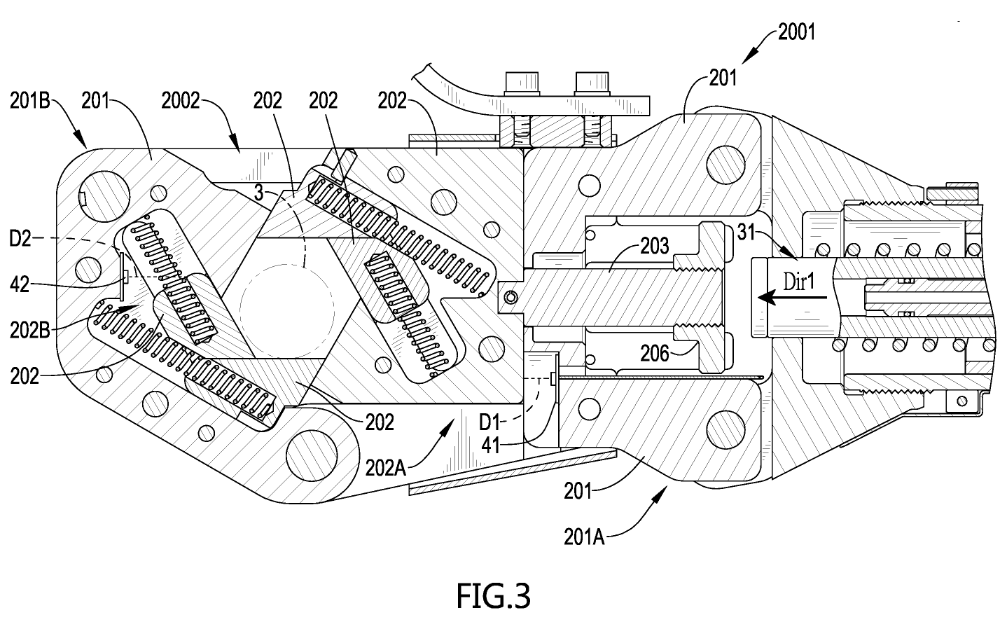

Further referring to FIG. 3, the die 2 has a fixed component 2001 and a movable component 2002. In one embodiment of the invention, the fixed component 2001 includes multiple fixed parts 201 as shown in FIG. 3. The movable component 2002 includes multiple movable parts 202 as shown in FIG. 3, a connecting part 203 and an adjusting ring 206. The connecting part 203 is cylindrical and extends toward the axial direction, and is fixedly connected to one of the movable parts 202. The cylindrical connecting part 203 has a first scale 204 engraved on one side. Correspondingly, one of the fixed parts 201 has a second scale 205 engraved. The adjusting ring 206 is adjustable and fixed around the cylindrical connecting part 203. When the invention does not use a power control program, a user of the invention can manually adjust the position of the adjustment ring 206 around the connection part 203 by referring to the position information presented by the first scale 204 and the second scale 205. A distance sensing unit 40 is provided in the fixed component 2001, and the distance sensing unit 40 is electrically connected to the control unit 10. The distance sensing unit 40 is used to sense a relative distance of the movable component 2002 relative to the fixed component 2001 to generate a distance sensing signal, and transmits the distance sensing signal to the control unit 10.

The control unit 10 receives the distance sensing signal and the pressure signal. When the control unit 10 controls the thrust rod 31 of the hydraulic jack 30 to move forward, the control unit 10 controls the hydraulic jack 30 to push the thrust rod 31 in a first direction Dir1. The thrust rod 31 is pushed forward in the first direction Dir1 for a distance and then contacts the connection part 203 of the movable component 2002. When the thrust rod 31 pushes the connection part 203 to move in the first direction Dir1, the component force of one of the connected moving parts 202 is used to move the other moving parts 202. When the connecting part 203 moving in the first direction Dir1 contacts one of the fixed components 2001, the connecting part 203 is blocked and stops moving in the first direction Dir1. In this way, even if the invention does not use power control, the user can ensure that the connecting portion 203 does not excessively move along the axis and excessively crimp the object. When the connecting portion 203 moving in the first direction Dir1 does not contact one of the fixed components 2001, the connecting portion 203 is moved by force and the component force is used to push the movable parts 202. If the push rod 31 continues to push toward the movable component 2002, the movable component 2002 under force starts to perform a crimping action to crimp a cable connector 3. The cable connector 3 for crimping is, in general, a cable connector of international standard. The cable connector can be inserted into a cable and deformed by crimping to be tightly combined with the cable. In order to successfully and tightly connect the cable connector 3 with an outer diameter to the cable, the force of the cable connector 3 being crimped must be adequate, otherwise the situation described in the previous technical paragraph will occur. The invention can automatically measure the outer diameter of the cable connector 3 to be crimped, so as to ensure that the cable connector 3 can be properly pressed and successfully crimped.

To accurately measure the outer diameter of the cable connector 3, the memory unit 20 stores a pressure threshold. For example, the pressure threshold may be preset to 30 bars. The control unit 10 determines whether the force applied to the push rod 31 is greater than or equal to the pressure threshold stored in the memory unit 20 according to the pressure signal.

The control unit 10 controls the hydraulic pump 34 to pressurize the pipeline 33 according to a start signal to push the thrust rod 31 toward the movable component 2002, so that the movable component 2002 can crimp the cable connector 3. When the control unit 10 determines that the force on the thrust rod 31 is greater than or equal to a pressure threshold according to the pressure signal, the control unit 10 determines that the movable component 2002 pushed by the thrust rod 31 begins to contact the cable connector 3, and at this time, the control unit 10 immediately calculates the outer diameter of the cable connector 3 according to the distance sensing signal received. On the contrary, when the control unit 10 determines that the force on the thrust rod 31 is less than the pressure threshold according to the pressure signal, the control unit 10 does not calculate the outer diameter of the cable connector 3 according to the distance sensing signal received. The method of measuring the outer diameter of the cable connector 3 in this way can be more accurate than calculating the outer diameter according to the hydraulic pressure change data of the hydraulic jack 30 moving the thrust rod 31. This is because there may be a slight mechanical error between the moving distance of the thrust rod 31 and the moving distance of the movable component 2002, and the outer diameter is more accurately measured based on the distance sensing unit 40 in the movable component 2002.

When the control unit 10 calculates the outer diameter of the cable connector 3, the control unit 10 controls the hydraulic jack 30 to push the thrust rod 31 toward the movable component 2002 by an adequate crimping distance according to an instruction corresponding to the outer diameter. And the control unit 10 further controls the hydraulic jack 30 to retract the thrust rod 31 to release the push and pressure on the movable component 2002.

The movable component 2002 of the die 2 can be applied to a variety of different cable connectors of different outer diameters on the market, so the user of the invention does not need to change the die 2 for various cable connectors of different outer diameters. Thus, the invention can help the user save effort in changing the die 2.

Furthermore, when the control unit 10 determines that the movable component 2002 begins to contact the cable connector 3, the control unit 10 can accurately measure the relative distance of the movable component 2002 relative to the fixed component 2001 according to the distance sensing signal generated by the distance sensing unit 40, and then calculate the outer diameter of the cable connector 3. Then the corresponding instruction can be automatically created, which only pushes the push rod 31 to move the adequate crimping distance to proper crimping of the cable connector 3. The cable connector 3 that is properly crimped, as described in the previous technical paragraph, can avoid being broken due to excessive force, or avoid being firmly combined with the cable inserted in the cable connector 3 due to insufficient force. In this way, the invention can automatically and accurately calculate the outer diameter of the cable connector 3, thereby helping the user save manpower to confirm the outer diameter of the cable connector 3, and making the crimping operation of the cable connector 3 smoother and more efficient.

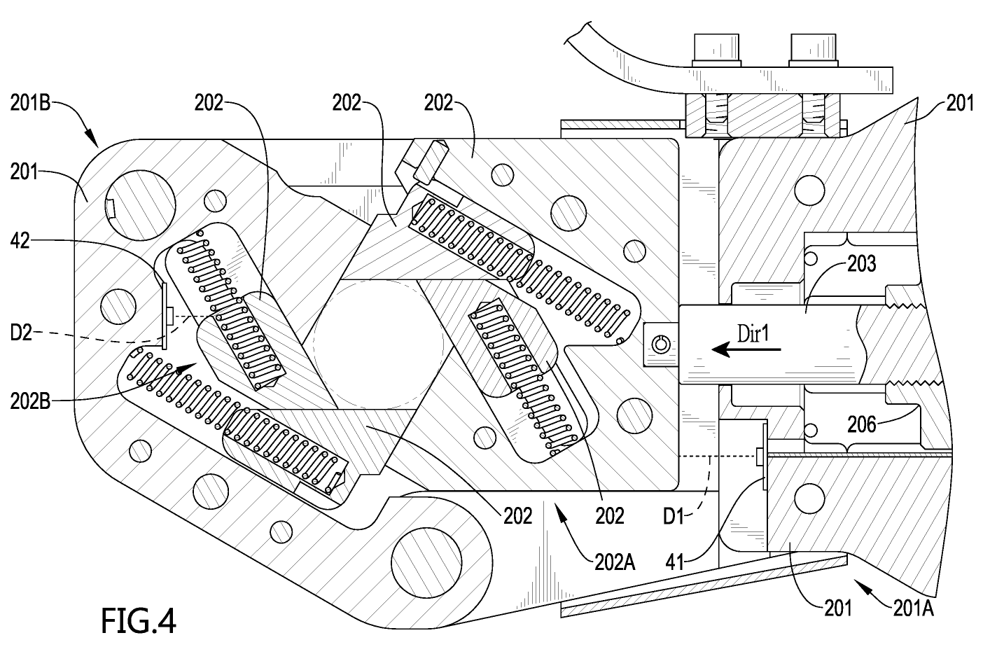

Referring to FIG. 2, FIG. 3 and FIG. 4, in an embodiment of the invention, the distance sensing unit 40 has multiple distance sensors, such as a first distance sensor 41 and a second distance sensor 42. The first distance sensor 41 and the second distance sensor 42 are electrically connected to the control unit 10 respectively. The first distance sensor 41 and the second distance sensor 42 are both optical distance sensors, such as infrared distance sensors. Each infrared distance sensor measures the relative distance of the movable component 2002 relative to the fixed component 2001 by calculating the infrared reflection distance to generate the distance sensing signal. In other embodiments, the distance sensors can be distance sensors of other numbers and other forms.

In this embodiment, the fixed parts 201 include a front fixed part 201A and a rear fixed part 201B. The movable parts 202 include a front movable part 202A and a rear movable part 202B. The first distance sensor 41 is arranged on the front fixed part 201A and faces the front movable part 202A of the movable component 2002 in the first direction Dir1. The first distance sensor 41 measures the first relative distance D1 of the front movable part 202A of the movable component 2002 relative to the front fixed part 201A and generates a first distance sensing signal. The second distance sensor 42 is arranged on the rear fixed part 201B and faces away from the first direction Dir1 towards the rear movable part 202B of the movable part 2002. The second distance sensor 42 measures the second relative distance D2 of the rear movable part 202B of the movable component 2002 relative to the rear fixed part 201B and generates a second distance sensing signal. When the connecting part 203 excessively moves toward the first direction Dir1, the adjusting ring 206 contacts the front fixed part 201A and is blocked by the front fixed part 201A.

When the control unit 10 calculates the outer diameter of the cable connector 3 according to the received distance sensing signal, the control unit 10 calculates the outer diameter of the cable connector 3 according to the received first distance sensing signal and the second distance sensing signal. In detail, the memory unit 20 further stores an outer diameter crimping distance lookup table, a first measurement lookup table, and a second measurement lookup table. When the control unit 10 calculates the outer diameter of the cable connector 3 according to the first distance sensing signal and the second distance sensing signal, the control unit 10 generates a first outer diameter result according to the first distance sensing signal and the first measurement lookup table, generates a second outer diameter result according to the second distance sensing signal and the second measurement lookup table, and then calculates an average value of the first outer diameter result and the second outer diameter result. The average value is the outer diameter of the cable connector 3. That is, if the invention has N distance sensors and N is a positive integer greater than 1, the invention generates N outer diameter results of the cable connector 3, and the average value of the N outer diameter results is the final outer diameter of the cable connector 3.

Referring to FIG. 3 and FIG. 4, FIG. 3 is a state diagram of the movable parts of the invention without force and movement, and FIG. 4 is a state diagram of the movable parts of the invention under force and moving to lightly contact the cable connector 3. Comparing FIG. 3 with FIG. 4, the distances measured by the first distance sensor 41 and the second distance sensor 42 are the distances of the vertically emitted and reflected ranging infrared rays by the first distance sensor 41 and the second distance sensor 42 in this embodiment, which change with the movement of the moving parts. In other embodiments, the arrangement of the first distance sensor 41 and the second distance sensor 42 can also be changed. The first distance sensor 41 and the second distance sensor 42 are still used to measure the change in the relative distance between the movable parts and the fixed parts before and after the movement.

After determining the outer diameter of the cable connector 3, the control unit 10 creates the instruction according to the outer diameter and the outer diameter crimping distance lookup table stored in the memory unit 20 to control the hydraulic jack 30 to push the thrust rod 31 to the adequate crimping distance.

In one embodiment, the invention further comprises a screen unit 50, an input unit 60 and a communication unit 70. The screen unit 50, the input unit 60 and the communication unit 70 are electrically connected to the control unit 10 respectively. The input unit 60 has multiple buttons electrically connected to the control unit 10 respectively, such as a forward key 61, a backward key 62, a menu key 63 and a setting key 64. The forward key 61, the backward key 62, the menu key 63, the setting key 64 and the screen unit 50 are all arranged on the housing 100 of the body 1. The user can view the information displayed on the screen unit 50 and operate the buttons of the input unit 60 to select at least one menu.

For example, by operating the buttons on the input unit 60, the user can set the mode of operation of the invention, such as switching a setting mode or a use mode. The setting mode can also be called a learning mode. Because in the setting mode, the control unit 10 of the invention can learn the user's operation to reproduce the operating parameters set by the user in the future in the use mode. In addition, the user can also operate the buttons on the input unit 60 to generate the start signal to the control unit 10.

When the control unit 10 receives a setting mode signal generated by the input unit 60, the control unit 10 enters the setting mode according to the setting mode signal. When the control unit 10 receives a use mode signal generated by the input unit 60, the control unit 10 exits the setting mode and enters the use mode according to the use mode signal.

When the control unit 10 is in the setting mode and receives a setting parameter signal generated by the input unit 60, the control unit 10 updates the outer diameter crimping distance lookup table stored in the memory unit 20 according to the setting parameter signal. When the control unit 10 is in the use mode and receives the start signal generated by the input unit 60, the control unit 10 starts to generate the instruction according to the outer diameter and the outer diameter crimping distance lookup table to control the hydraulic jack 30 to push the thrust rod 31 to the adequate crimping distance.

In other words, in this embodiment, the user can set parameters in advance through the input unit 60. When a new cable connector 3 is crimped in the invention through the input unit 60, the invention can fully-automatically measure the outer diameter of the cable connector 3 after receiving the start signal and directly and adequately crimp the cable connector 3 based on the measured outer diameter and pre-set parameters.

Furthermore, the instruction of the outer diameter set by the control unit 10 also includes a retraction distance corresponding to the outer diameter. After the control unit 10 controls the hydraulic jack 30 to push the thrust rod 31 toward the movable component 2002 by the adequate crimping distance according to the instruction, the control unit 10 controls the hydraulic jack 30 to retract the thrust rod 31 according to the retraction distance.

In another embodiment, when the control unit 10 calculates the outer diameter of the cable connector 3, the control unit 10 controls the screen unit 50 to display an outer diameter information corresponding to the outer diameter. In addition, in the use mode, the control unit 10 provides the user with the option of confirming whether the outer diameter information displayed by the screen unit 50 is reasonable. Because in some specific application fields, there may be a small probability that the cable connector 3 does not meet the specifications of international regulations. In such a case, an inner diameter distance of the cable connector 3 may not correspond to the outer diameter distance in accordance with international regulations, so that the user needs to confirm the specifications of the cable connector 3 more carefully. In this relatively rare case, the invention can be designed in a semi-automatic working mode to give the user the option of confirming whether the outer diameter information is reasonable.

When the user confirms that the outer diameter information is reasonable, the user can confirm it by operating the input unit 60. When the control unit 10 receives a confirmation signal generated by the input unit 60, the control unit 10 further controls the hydraulic jack 30 to push the thrust rod 31 toward the movable component 2002 to the adequate crimping distance according to the instruction. When the control unit 10 receives a rejection signal generated by the input unit 60, the control unit 10 exits the use mode and enters the setting mode, so that the user can readjust the parameters by operating the input unit 60. That is, in the setting mode, the control unit 10 updates the instruction corresponding to the outer diameter according to the setting parameter signal generated by the input unit 60.

In addition, the communication unit 70 of the invention communicates with an external device to connect an external device. The external device can be any electronic device with electronic access functions, and the communication unit 70 is not limited to the way of communication connection with the external device. For example, the external device can be a remote control, and the remote control can wirelessly remotely control the invention by radio frequency (RF). For example, the remote control can generate the setting parameter signal for setting the parameters of the invention. When the control unit 10 receives the setting parameter signal from the external device through the communication unit 70, the control unit 10 can update the outer diameter crimping distance lookup table stored in the memory unit 20 according to the setting parameter signal to adjust the stroke of crimping the cable connector 3.

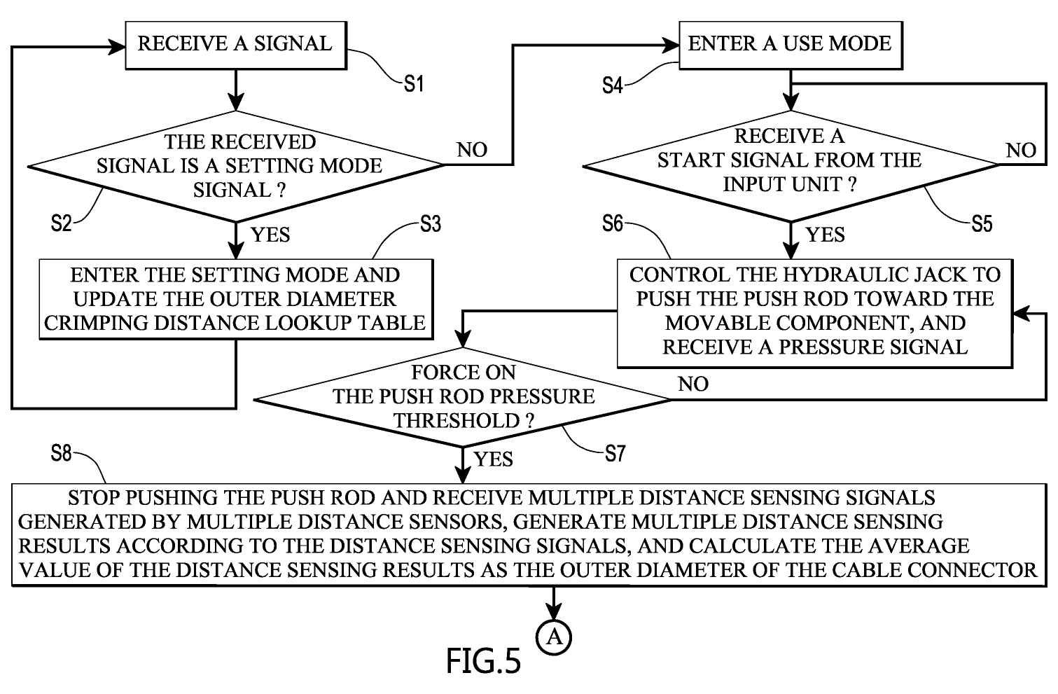

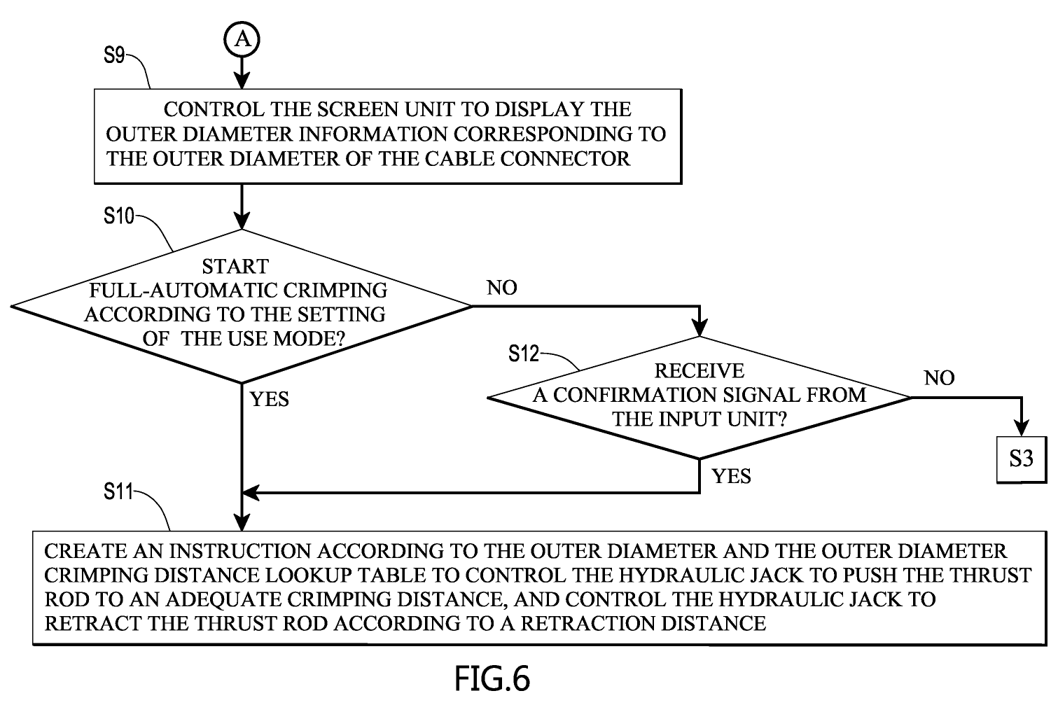

Referring to FIG. 5 and FIG. 6, the control unit 10 in one embodiment executes the following steps:

S1: receiving a signal. For example, the signal is generated by the input unit 60 or the external device.

S2: determining whether the received signal is the setting mode signal.

S3: when determining that the received signal is the setting mode signal, entering the setting mode and further updating the outer diameter crimping distance lookup table stored in the memory unit 20 according to the received setting parameter signal, such as the crimped setting parameter signal, and executing S1.

S4: when determining that the received signal is not the setting mode signal, determining that the received signal is the use mode signal and entering the use mode.

S5: determining whether the start signal is received from the input unit 60, executing S5 when the start signal has not been received.

S6: when determining that the start signal is received, controlling the hydraulic jack 30 to push the push rod 31 toward the movable component 2002, and receiving the pressure signal from the hydraulic jack 30.

S7: determining whether the force on the push rod 31 is greater than or equal to the pressure threshold according to the pressure signal; and when determining the force on the push rod 31 is less than the pressure threshold, executing S6.

S8: when determining that the force on the push rod 31 is greater than or equal to the pressure threshold, stopping pushing the push rod 31 and receiving multiple distance sensing signals generated by multiple distance sensors, generating multiple distance sensing results according to the distance sensing signals, and calculating the average value of the distance sensing results as the outer diameter of the cable connector.

S9: controlling the screen unit 50 to display the outer diameter information corresponding to the outer diameter.

S10: determining whether to start full-automatic crimping according to the setting of the use mode. Wherein the setting of the use mode is the setting parameter adjusted in the setting mode.

S11: when determining that full-automatic crimping is started, creating the instruction according to the outer diameter and the outer diameter crimping distance lookup table to control the hydraulic jack 30 to push the thrust rod 31 to the adequate crimping distance and controlling the hydraulic jack 30 to retract the thrust rod 31 according to the retraction distance.

S12: when determining that full-automatic crimping is not started, further determining whether the confirmation signal is received from the input unit; when determining that the confirmation signal is received, executing S11; when determining that the confirmation signal is not received, determining that the rejection signal is received and executing S3.

Although the invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the invention, are contemplated thereby, and are intended to be covered by the following claims.

What is claimed is:

1. A hydraulic crimper free from die change comprising:
a die including a fixed component and a movable component; wherein a distance sensing unit is installed to the fixed component for sensing a relative distance between the moveable component and the fixed component and thus correspondingly generates a distance sensing signal;
a main body connected to the die and comprising:
a hydraulic jack, having a thrust rod, a pipeline, a hydraulic pump, and a hydraulic sensor; wherein, the pipeline connects the hydraulic pump to the thrust rod, and the hydraulic sensor senses a force on the pipeline to generate a pressure signal;
a control unit, electrically connected to the distance sensing unit, the hydraulic pump and the hydraulic sensor to receive the distance sensing signal and the pressure signal; wherein, the control unit controls the hydraulic pump to pressurize the pipeline according to a start signal to push the thrust rod toward the moveable component such that the moveable component crimps a cable connector;
wherein, when the control unit determines that force on the pipeline is greater than or equal to a pressure threshold according to the pressure signal, the control unit calculates an outer diameter of the cable connector according to the received distance sensing signal;
wherein, the control unit controls the hydraulic jack to push the thrust rod toward the moveable component for a crimping distance according to an instruction that corresponds to the outer diameter of the cable connector, and further controls the hydraulic jack to retract the thrust rod.

2. The hydraulic crimper free from die change as claimed in claim 1, further comprising:
a memory unit, electrically connected to the control unit and storing the pressure threshold and an outer diameter crimping distance lookup table;
wherein the control unit creates the instruction according to the outer diameter and the outer diameter crimping distance lookup table to control the hydraulic jack to push the thrust rod to the crimping distance.

3. The hydraulic crimper free from die change as claimed in claim 2, further comprising:
an input unit electrically connected to the control unit;
wherein, when the control unit receives a setting mode signal generated by the input unit, the control unit enters a setting mode, and when the control unit receives a use mode signal generated by the input unit, the control unit exits the setting mode and enters the use mode;
wherein, when the control unit is in the setting mode and the control unit receives a setting parameter signal generated by the input unit, the control unit updates the outer diameter crimping distance lookup table stored in the memory unit according to the setting parameter signal;
wherein, when the control unit is in the use mode and receives the start signal generated by the input unit, the control unit starts to determine the instruction according to the outer diameter and the outer diameter crimping distance lookup table to control the hydraulic jack to push the thrust rod to the crimping distance.

4. The hydraulic crimper free from die change as claimed in claim 2, further comprising:
a communication unit, electrically connected to the control unit for communication connection to an external device;
wherein, when the control unit receives a set parameter signal from the external device through the communication unit, the control unit updates the outer diameter crimping distance lookup table stored in the memory unit based on the set parameter signal.

5. The hydraulic crimper free from die change as claimed in claim 1, wherein, the distance sensing unit further includes at least one optical distance sensor, and the at least one optical distance measures the relative distance of the moveable component relative to the fixed component in an optical manner to generate the distance sensing signal.

6. The hydraulic crimper free from die change as claimed in claim 5, wherein, the optical distance sensor at least includes a first distance sensor and a second distance sensor, and the thrust rod pushes the movable component in a first direction;
wherein, the first distance sensor is oriented in the first direction facing the movable component to measure the first relative distance between the movable component and the fixed component, and generates a first distance sensing signal; the second distance sensor is oriented in an opposite direction of the first direction facing the movable component to measure the second relative distance between the movable component and the fixed component and generates a second distance sensing signal;
wherein, when the control unit calculates the outer diameter of the cable connector based on the received distance sensing signals, the control unit calculates the outer diameter of the cable connector based on the received first distance sensing signal and the second distance sensing signal.

7. The hydraulic crimper free from die change as claimed in claim 6, further comprising:
a memory unit electrically connected to the control unit and storing the pressure threshold, a first measurement lookup table, and a second measurement lookup table;
wherein, when the control unit calculates the outer diameter of the cable connector based on the first distance sensing signal and the second distance sensing signal, the control unit generates a first outer diameter result based on the first distance sensing signal and the first measurement lookup table, generates a second outer diameter result based on the second distance sensing signal and the second measurement generates table, and then averages the first and second outer diameter results to calculate the outer diameter of the cable connector.

8. The hydraulic crimper free from die change as claimed in claim 6, further comprising:
an input unit electrically connected to the control unit;
a screen unit electrically connected to the control unit;
wherein, when the control unit calculates the outer diameter of the cable connector, the control unit controls the screen unit to display an outer diameter information corresponding to the outer diameter;
wherein, when the control unit receives a confirmation signal from the input unit, the control unit further controls the hydraulic jack to push the thrust rod to the crimping distance based on the instruction.

9. The hydraulic crimper free from die change as claimed in claim 8, wherein when the control unit receives a rejection signal from the input unit, the control unit exits an operating mode and enters a setting mode;
wherein, when the control unit is in the setting mode and receives a setting parameter signal from the input unit, the control unit updates the instruction corresponding to the outer diameter based on the setting parameter signal.

10. The hydraulic crimper free from die change as claimed in claim 1, wherein the instruction corresponding to the outer diameter includes a retraction distance corresponding to the outer diameter; after the control unit controls the hydraulic jack to push the thrust rod to the crimping distance towards the movable component, the control unit controls the hydraulic jack to retract the thrust rod based on the retraction distance.

11. The hydraulic crimper free from die change as claimed in claim 1, wherein the movable component of the die further includes:
multiple movable parts for crimping the cable connector;
a connecting part, extending in cylindrical along one axis, and connected to one of the movable parts;
an adjustable ring adjustably mounted around the cylindrical connecting part;
wherein, when the thrust rod pushes the movable component, the thrust rod pushes the connecting part to move along the axis, thereby moving the movable parts through the component force of the connected one of the movable parts;
wherein, when the connecting part moving along the axis contacts the fixed component, the connecting part stops moving along the axis.
